(19) United States
(12) Patent Application Publication
(10) Pub. No.: US 2012/0295168 A1
(43) Pub. Date: Nov. 22, 2012

(54) PHASE-PURE LITHIUM ALUMINIUM TITANIUM PHOSPHATE AND METHOD FOR ITS PRODUCTION AND USE

(75) Inventors: Michael Holzapfel, Freising (DE); Genovefa Wendrich, Essenbach (DE); Stefanie Busl, Hallbergmoos (DE); Gerhard Nuspl, Munchen (DE)

(73) Assignee: SUD-CHEMIE AG, Munchen (DE)

(21) Appl. No.: 13/502,290

(22) PCT Filed: Oct. 13, 2010
(86) PCT No.: PCT/EP2010/006267

§ 371 Date: Aug. 3, 2012

(30) Foreign Application Priority Data
Oct. 16, 2009 (DE) 10 2009 049 694.7

(51) Int. Cl. H01M 10/0562

(52) U.S. Cl. 429/319

(57) ABSTRACT

The present invention relates to a method for producing lithium aluminium titanium phosphates of the general formula Li₁₊ₓTi₂₋ₓAlₓ(PO₄)₃, wherein x is ≦0.4, as well as their use as solid electrolytes in secondary lithium ion batteries.

The present invention relates to phase-pure lithium aluminium titanium phosphate, a method for its production, its use, as well as a secondary lithium ion battery containing the phase-pure lithium aluminium titanium phosphate.

Recently, battery-powered motor vehicles have increasingly become the focal point of research and development because of the increasing lack of fossil raw materials.

In particular lithium ion accumulators (also called secondary lithium ion batteries) proved to be the most promising battery models for such applications.

These so-called “lithium ion batteries” are also widely used in fields such as power tools, computers, mobile telephones etc. In particular the cathodes and electrolytes, but also the anodes, consist of lithium-containing materials.

LiMn₂O₄ and LiCoO₂ for example have been used for some time as cathode materials. Recently, in particular since the work of Goodenough et al. (U.S. Pat. No. 5,910,382), also doped or non-doped mixed lithium transition metal phosphates, in particular LiFePO₄.

Normally, for example graphite or also, as already mentioned above, lithium compounds such as lithium titanates are used as anode materials in particular for large-capacity batteries.

By lithium titanates are meant here the doped or non-doped lithium titanium spinels of the Li₁₊ₓTi₂₋ₓO₄ type with 0≦x≦⅓ of the space group Fd3m and all mixed titanium oxides of the generic formula LiₓTi_{y}O(0≦x,y≦1).

Normally, lithium salts or their solutions are used for the solid electrolyte in such secondary lithium ion batteries.

Ceramic separators such as Separion® commercially available in the meantime for example from Evonik Degussa (DE 196 53 484 A1) have also been proposed. However, Separion contains, not a solid-state electrolyte, but ceramic fillers such as nanoscale Al₂O₃ and SiO₂.

Lithium titanium phosphates have for some time been mentioned as solid electrolytes (JP A 1990 2-225310). Lithium titanium phosphates have, depending on the structure and doping, an increased lithium ion conductivity and a low electrical conductivity, which, also in addition to their great hardness, makes them very suitable as solid electrolytes in secondary lithium ion batteries.

Aono et al. have examined the ionic (lithium) conductivity of doped and non-doped lithium titanium phosphates (J. Electrochem. Soc., Vol. 137, No. 4, 1990, pp. 1023-1027, J. Electrochem. Soc., Vol. 136, No. 2, 1989, pp. 590-591).

Systems doped with aluminium, scandium, yttrium and lanthanum in particular were examined. It was found that in particular doping with aluminium delivers good results because, depending on the degree of doping, aluminium has the highest lithium ion conductivity compared with other doping metals and, because of its cation radius (smaller than Ti⁴⁺) in the crystal, it can well take the spaces occupied by the titanium.

Kosova et al. in Chemistry for Sustainable Development 13 (2005) 253-260 propose suitable doped lithium titanium phosphates as cathodes, anodes and electrolyte for rechargeable lithium ion batteries.

Li_{1.3}Al_{0.3}Ti_{1.7}(PO₄) was proposed in EP 1 570 113 B1 as ceramic filler in an “active” separator film which has additional ion conductivity for electrochemical components.

Likewise, further doped lithium titanium phosphates, in particular doped with iron, aluminium and rare earths, were described in U.S. Pat. No. 4,985,317.

However, very expensive synthesis by means of solid-state synthesis starting from solid phosphates, in which the thus-obtained corresponding lithium titanium phosphate is normally contaminated by further foreign phases such as for example AlPO₄ or TiP₂O₇, is common to all of the above-named lithium titanium phosphates. Phase-pure lithium titanium phosphate or doped lithium titanium phosphate has been unknown thus far.

The object of the present invention was therefore to provide phase-pure lithium aluminium titanium phosphate, because phase-pure lithium aluminium titanium phosphate combines the characteristics of a high lithium ion conductivity with a low electrical conductivity. An even better ionic conductivity compared with non-phase-pure lithium aluminium titanium phosphate of the state of the art should also be obtained because of the absence of foreign phases.

This object is achieved by the provision of phase-pure lithium aluminium titanium phosphate of the formula Li₁₊ₓTi₂₋ₓAlₓ(PO₄)₃, wherein x is ≦0.4 and the level of magnetic metals and metal compounds of the elements Fe, Cr and Ni therein is ≦1 ppm.

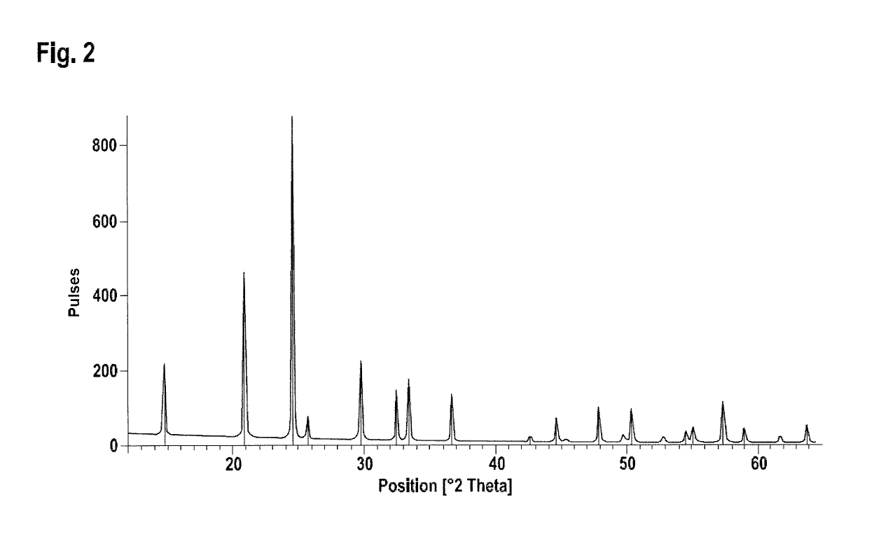

Here, by the term “phase-pure” is meant that reflexes of foreign phases cannot be recognized in the X-ray powder diffractogram (XRD). The absence of foreign-phase reflexes in lithium aluminium titanium phosphates according to the invention, as is shown by way of example in FIG. 2 below, corresponds to a maximum proportion of foreign phases, such as e.g. AlPO₄ and TiP₂O₇, of 1%.

As already stated above, foreign phases reduce the intrinsic ion conductivity, with the result that, compared with those of the state of the art, all of which contain foreign phases, the phase-pure lithium aluminium titanium phosphates according to the invention have a higher intrinsic conductivity than the lithium aluminium titanium phosphates of the state of the art.

Surprisingly, it was also found that the total level of magnetic metals and metal compounds of Fe, Cr and Ni (ΣFe+Cr+Ni) in the lithium aluminium titanium phosphate according to the invention is ≦1 ppm. When account is also taken of any disruptive zinc, the total content ΣFe+Cr+Ni+Zn is ≦1.1 ppm, compared with 2.3-3.3 ppm of a lithium aluminium titanium phosphate according to the above-named state of the art.

In particular, the lithium aluminium titanium phosphate according to the invention displays only an extremely small contamination by metallic or magnetic iron and magnetic iron compounds (such as e.g. Fe₃O₄) of <0.5 ppm. The determination of the concentrations of magnetic metals or metal compounds is described in detail below in the experimental section. Customary values for magnetic iron or magnetic iron compounds in the lithium aluminium titanium phosphates previously known from the state of the art are approx. 1-1000 ppm. The result of contamination by metallic iron or magnetic iron compounds is that in addition to the formation of dendrites associated with a drop in current the danger of short circuits within an electrochemical cell in which lithium aluminium titanium phosphate is used as solid electrolyte increases significantly and thus represents a risk for the production of such cells on an industrial scale. This disadvantage can be avoided with the phase-pure lithium aluminium titanium phosphate here.

Equally surprisingly, the phase-pure lithium aluminium titanium phosphate according to the invention also has a relatively high BET surface area of <3.5 m²/g. Typical values are for example 2.7 to 3.1 m²/g, depending on the duration of the synthesis. Lithium aluminium titanium phosphates known from the literature on the other hand have BET surface areas of less than 2 m²/g, in particular less than 1.5 m²/g.

The lithium aluminium titanium phosphate according to the invention preferably has a particle-size distribution of d₉₀<6 μm, d₅₀<2.1 μm and d₁₀<1 μm, which results in the majority of the particles being particularly small and thus a particularly high ion conductivity being achieved. This confirms similar findings from the above-mentioned Japanese unexamined patent application, where it was also attempted to obtain smaller particle sizes by means of various grinding processes. Because of the extreme hardness of the lithium aluminium titanium phosphate (Mohs' hardness >7, i.e. close to diamond), this is difficult to obtain with customary grinding processes, however.

In further preferred embodiments of the present invention, the lithium aluminium titanium phosphate has the following empirical formulae: Li_{1.2}Ti_{1.8}Al_{0.2}(PO₄)₃, which has a very good total ion conductivity of approx. 5×10⁻⁴ S/cm at 298 K and—in the particularly phase-pure form—Li_{1.3}Ti_{1.7}Al_{0.3}(PO₄)₃, which has a particularly high total ion conductivity of 7×10⁻⁴ S/cm at 293 K.

The object of the present invention was furthermore to provide a method for producing the phase-pure lithium aluminium titanium phosphate according to the invention. This object is achieved by a method which comprises the following steps:
a) providing a phosphoric acid
b) adding titanium dioxide
c) converting the mixture at a temperature of more than 100° C.
d) adding an oxygen-containing aluminium compound and a lithium compound
e) calcining the suspended reaction product obtained in step d).

Surprisingly it was found that, unlike all previously known syntheses of the state of the art, a liquid phosphoric acid, i.e. typically an aqueous phosphoric acid, can also be used instead of solid phosphoric acid salts. The method according to the invention can also be called a “hydrothermal method”. The use of a phosphoric acid makes possible a simpler execution of the method and thus also the option of removing impurities already in solution or suspension in solution and thus also obtaining products with greater phase purity. In particular, a dilute phosphoric acid in aqueous solution is used according to the invention.

The first reaction step c) of the method according to the invention solubilizes the otherwise inert TiO₂ and, via the intermediate product Ti₂O(PO₄)₂ that need not necessarily be isolated within the framework of the method according to the invention, makes possible a faster and better reaction in the following step d) and an end product that can be better isolated.

The intermediate product Ti₂O(PO₄)₂ need not necessarily be isolated, because the method according to the invention is preferably carried out as a “one-pot method”. In further developments of the invention that are, however, not quite so preferred, it is also possible to isolate and optionally purify the Ti₂O(PO₄)₂ by methods known per se to a person skilled in the art, such as precipitation, spray-drying, etc., and then carry out the further method steps d) and e). This execution of the method may be recommended in particular when using phosphoric acids other than orthophosphoric acid. However, after separation of the Ti₂O(PO₄)₂, phosphoric acid or alternatively a phosphate must be added again in order that the end product has the right stoichiometry.

As already stated, a dilute orthophosphoric acid, e.g. in the form of a 30% to 50% solution, is preferably used as phosphoric acid, although in less preferred further embodiments of the present invention other phosphoric acids can also be used, such as for example metaphosphoric acid etc. All condensation products of orthophosphoric acid can also be used according to the invention such as: catenary polyphosphoric acids (diphosphoric acid, triphosphoric acid, oligophosphoric acids, etc.) annular metaphosphoric acids (tri-, tetrametaphosphoric acid) up to the anhydride of phosphoric acid P₂O₅. It is important according to the invention only that all of the above-named phosphoric acids are used in diluted form in solution, preferably in aqueous solution.

According to the invention any suitable lithium compound can be used as lithium compound, such as Li₂CO₃, LiOH, Li₂O, LiNO₃, wherein lithium carbonate is particularly preferred because it is most cost-favourable, in particular when used on an industrial scale. Typically, according to the invention, the aluminium compound is not added until step d) and the lithium compound only after 30 min. to 1 h. This reaction process is also called “cascade phosphating” in the present case.

Practically any oxide or hydroxide or mixed oxide/hydroxide of aluminium can be used as oxygen-containing aluminium compound. Aluminium oxide Al₂O₃ is preferably used in the state of the art because of its ready availability. In the present case it was found, however, that the best results are achieved with Al(OH)₃. Al(OH)₃ is even more cost-favourable compared with Al₂O₃ and also more reactive than Al₂O₃, in particular in the calcining step. Of course, Al₂O₃ can also be used in the method according to the invention, albeit less preferably; however, the calcining in particular then lasts longer compared with using Al(OH)₃.

The step of heating the mixture of phosphoric acid and titanium dioxide (“phosphating”) is carried out at a temperature of more than 100° C., in particular in a range of from 140 to 200° C., preferably 140 to 180° C. A gentle conversion, which moreover can still be controlled, into a homogeneous product is thereby guaranteed.

The reaction product obtained according to the invention from step d) is then isolated by normal methods, e.g. evaporation or spray-drying. A spray-drying is particularly preferred.

The calcining takes place preferably at temperatures of from 850-950° C., quite particularly preferably at 880-900° C., as below 850° C. the danger of the occurrence of foreign phases is particularly great.

Typically, the vapour pressure of the lithium in the compound Li₁₊ₓTi₂₋ₓAlₓ(PO₄)₃ also increases at temperatures of >950° C., i.e. at temperatures >950° C. the formed compounds Li₁₊ₓTi₂₋ₓAlₓ(PO₄)₃ lose more and more lithium which settles as Li₂O and Li₂CO₃ on the oven walls in an air atmosphere. This can be compensated for e.g. by the lithium excess described below, but the precise setting of the stoichiometry becomes more difficult. Therefore, lower temperatures are preferred and surprisingly also possible by the previous execution of the method compared with the state of the art. This result can be attributed to the use of dilute phosphoric acid compared with solid phosphates of the state of the art.

In addition, temperatures of >1000° C. make greater demands of the oven and crucible material.

The calcining is carried out over a period of from 5 to 24 hours, preferably 10 to 18 hours, quite particularly preferably 12 to 15 hours. It was surprisingly found that, unlike with methods of the state of the art, a single calcining step is sufficient to obtain a phase-pure product.

Because the execution of the method according to the invention is hydrothermal, a stoichiometric excess of lithium starting compound normal in the state of the art is not necessary for step d). Lithium compounds are not volatile at the used reaction temperatures according to the invention. Moreover, because the execution of the method is hydrothermal, monitoring of the stoichiometry is made particularly easy compared with a solid-state method.

The subject of the present invention is also a phase-pure lithium aluminium titanium phosphate of the formula Li₁₊ₓTi₂₋ₓAlₓ(PO₄)₃ wherein x is ≦0.4, which can be obtained by the method according to the invention and can be obtained particularly phase-pure within the meaning of the above definition by the hydrothermal execution of the method. All previously known products obtainable by solid-state synthesis methods—as already said above—had foreign phases, something which is avoided by the hydrothermal execution of the method according to the invention. In addition, previously known products obtainable by solid-state synthesis methods had larger quantities of disruptive magnetic impurities.

The subject of the invention is also the use of the phase-pure lithium aluminium titanium phosphate according to the invention as solid electrolyte in a secondary lithium ion battery.

The object of the invention is further achieved by providing an improved secondary lithium ion battery which contains the phase-pure lithium aluminium titanium phosphate according to the invention, in particular as solid electrolyte. Because of its high lithium ion conductivity, the solid electrolyte is particularly suitable and, because of its phase purity and low iron content, particularly stable and also resistant to short circuits.

In preferred developments of the present invention, the cathode of the secondary lithium ion battery according to the invention contains a doped or non-doped lithium transition metal phosphate as cathode, wherein the transition metal of the lithium transition metal phosphate is selected from Fe, Co, Ni, Mn, Cr and Cu. Doped or non-doped lithium iron phosphate LiFePO₄ is particularly preferred.

In yet further preferred developments of the present invention, the cathode material additionally contains a doped or non-doped mixed lithium transition metal oxo compound different from the lithium transition metal phosphate used. Lithium transition metal oxo compounds suitable according to the invention are e.g. LiMn₂O₄, LiNiO₂, LiCoO₂, NCA (LiNi_{1-x-y}CoₓAl_{y}O₂, e.g. LiNi_{0.8}Co_{0.15}Al_{0.05}O₂) or NCM (LiNi_{1/3}Co_{1/3}Mn_{1/3}O₂). The proportion of lithium transition metal phosphate in such a combination lies in the range of from 1 to 60 wt.-%. Preferred proportions are e.g. 6-25 wt.-%, preferably 8-12 wt.-% in an LiCoO₂/LiFePO₄ mixture and 25-60 wt.-% in an LiNiO₂/LiFePO₄ mixture.

In yet further preferred developments of the present invention, the anode material of the secondary lithium ion battery according to the invention contains a doped or non-doped lithium titanate. In less preferred developments the anode material contains exclusively carbon, for example graphite etc. The lithium titanate in the preferred development mentioned above is typically doped or non-doped Li₄Ti₅O₁₂, with the result that for example a potential of 2 volts vis-à-vis the preferred cathode of lithium transition metal phosphate can be achieved.

As already stated above, both the lithium transition metal phosphates of the cathode material as well as the lithium titanates of the anode material of the preferred development are either doped or non-doped. Doping takes place with at least one further metal or also with several, which leads in particular to an increased stability and cycle stability of the doped materials when used as cathode or anode. Metal ions such as Al, B, Mg, Ga, Fe, Co, Sc, Y, Mn, Ni, Cr, V, Sb, Bi, Nb or several of these ions, which can be incorporated in the lattice structure of the cathode or anode material, are preferred as doping material. Mg, Nb and Al are quite particularly preferred. The lithium titanates are normally preferably rutile-free and thus equally phase-pure.

The doping metal cations are present in the above-named lithium transition metal phosphates or lithium titanates in a quantity of from 0.05 to 3 wt.-%, preferably 1 to 3 wt.-% relative to the total mixed lithium transition metal phosphate or lithium titanate. Relative to the transition metal (values in at %) or, in the case of lithium titanates, relative to lithium and/or titanium, the quantity of doping metal cation(s) is up to 20 at %, preferably 5-10 at %.

The doping metal cations occupy either the lattice positions of the metal or of the lithium. Exceptions to this are mixed Fe, Co, Mn, Ni, Cr, Cu, lithium transition metal phosphates which contain at least two of the above-named elements, in which larger quantities of doping metal cations may also be present, in the extreme case up to 50 wt.-%.

Typical further constituents of an electrode of the secondary lithium ion battery according to the invention are, in addition to the active material, i.e. the lithium transition metal phosphate or the lithium titanate, carbon blacks as well as a binder.

Binders known per se to a person skilled in the art may be used here as binder, such as for example polytetrafluoroethylene (PTFE), polyvinylidene difluoride (PVDF), polyvinylidene difluoride hexafluoropropylene copolymers (PVDF-HFP), ethylene-propylene-diene terpolymers (EPDM), tetrafluoroethylene hexafluoropropylene copolymers, polyethylene oxides (PEO), polyacrylonitriles (PAN), polyacryl methacrylates (PMMA), carboxymethylcelluloses (CMC), and derivatives and mixtures thereof.

Within the framework of the present invention, typical proportions of the individual constituents of the electrode material are preferably 80 to 98 parts by weight active material electrode material, 10 to 1 parts by weight conductive carbon and 10 to 1 parts by weight binder.

Within the framework of the present invention, preferred cathode/solid electrolyte/anode combinations are for example LiFePO₄/Li_{1.3}Ti_{1.7}Al_{0.3}(PO₄)₃/LiₓTi_{y}O with a single-cell voltage of approx. 2 volts which is well suited as substitute for lead-acid cells or LiCo_{z}Mn_{y}FeₓPO₄/Li_{1.3}Ti_{1.7}Al_{0.3} (PO₄)₃/LiₓTi_{y}O, wherein x, y and z are as defined further above, with increased cell voltage and improved energy density.

The invention is explained in more detail below with the help of drawings and examples which are not to be understood as limiting the scope of the present invention. There are shown in:

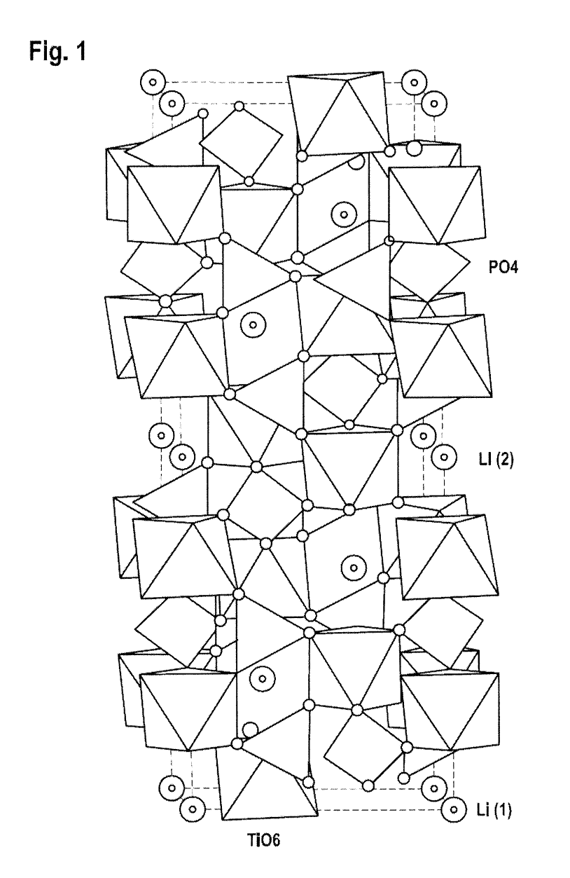

FIG. 1 the structure of the phase-pure lithium aluminium titanium phosphate according to the invention,

FIG. 2 an XRD spectrum of a lithium aluminium titanium phosphate according to the invention,

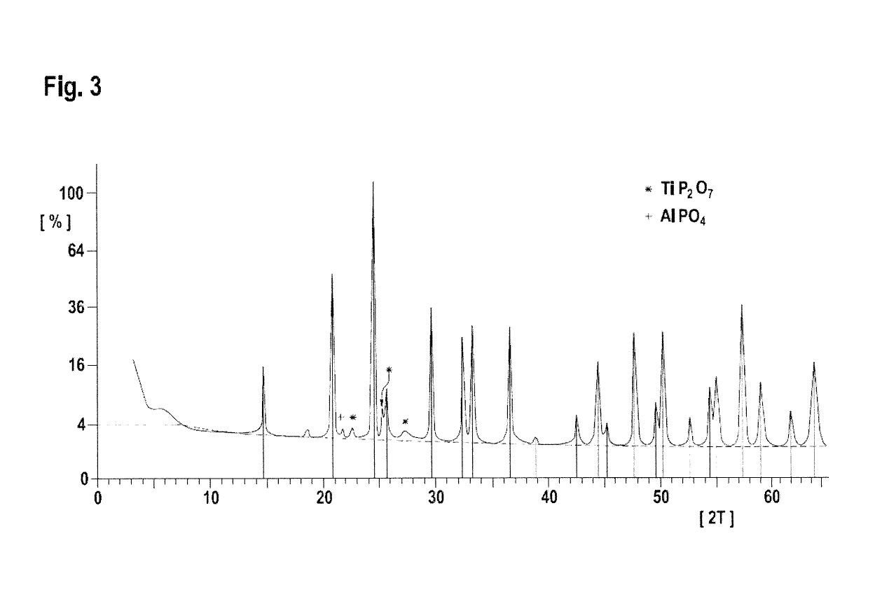

FIG. 3 an X-ray powder diffractogram (XRD) of a conventionally produced lithium aluminium titanium phosphate,

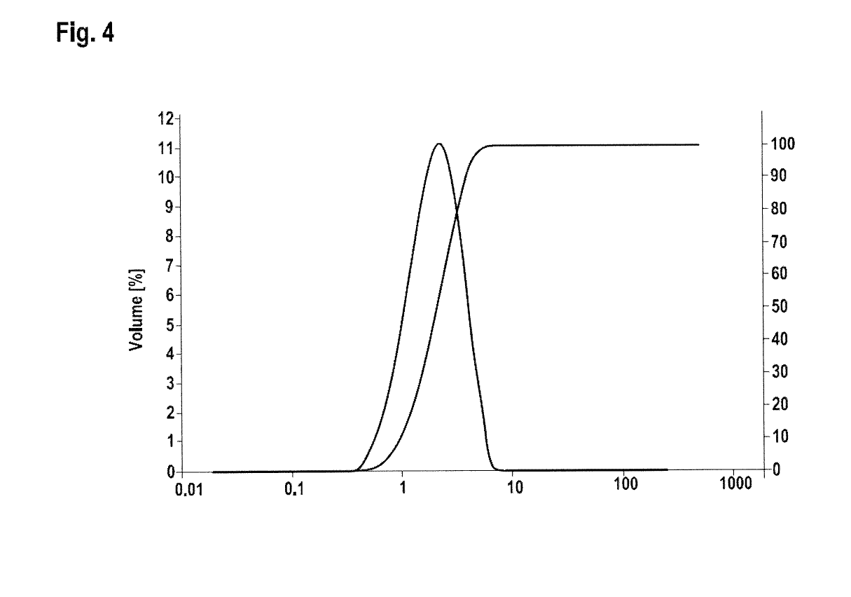

FIG. 4 the particle-size distribution of the lithium aluminium titanium phosphate according to the invention.

### 1. MEASUREMENT METHODS

The BET surface area was determined according to DIN 66131 (DIN-ISO 9277).

The particle-size distribution was determined according to DIN 66133 by means of laser granulometry with a Malvern Mastersizer 2000.

The X-ray powder diffractogram (XRD) was measured with an X'Pert PRO diffractometer, PANalytical: Goniometer Theta/Theta, Cu anode PW 3376 (max. output 2.2 kW), detector X'Celerator, X'Pert Software.

The level of magnetic constituents in the lithium aluminium titanium phosphate according to the invention is determined by separation by means of magnets followed by decomposition by acid and subsequent ICP analysis of the formed solution.

The lithium aluminium titanium phosphate powder to be examined is suspended in ethanol with a magnet of a specific size (diameter 1.7 cm, length 5.5 cm<6000 Gauss). The ethanolic suspension is exposed to the magnet in an ultrasound bath with a frequency of 135 kHz for 30 minutes. The magnet attracts the magnetic particles from the suspension or the powder. The magnet with the magnetic particles is then removed from the suspension. The magnetic impurities are dissolved with the help of decomposition by acid and this is examined by means of ICP (ion chromatography) analysis, in order to determine the precise quantity as well as the composition of the magnetic impurities. The apparatus for ICP analysis was an ICP-EOS, Varian Vista Pro 720-ES.

### EXAMPLE 1

Production of Li_{1.3}Al_{0.3}Ti_{1.7}(PO₄)₃

29.65 kg orthophosphoric acid (80%) was introduced into a reaction vessel (Thale container 200 l capacity) and diluted with deionized water to a liquid quantity of 110 l, which corresponds to a 2.2 M orthophosphoric acid. 10.97 kg TiO₂ (in anatase form) was then added slowly accompanied by vigorous stirring with a Teflon-coated anchor stirrer and stirring continued at 160° C. for 16 h. The reaction mixture was then cooled to 80° C. and 1.89 kg Al(OH₃) (Gibbsite) added and stirring continued for half an hour. 4.65 kg LiOH dissolved in 23 l deionized water was then added. Towards the end of the addition, the colourless suspension became more viscous. The suspension was then spray-dried and the thus-obtained non-hygroscopic crude product finely ground over a period of 6 hours, in order to obtain a particle size <50 μm.

The finely ground premixture was heated from 200 to 900° C. within six hours at a heat-up rate of 2° C. per minute, as otherwise amorphous foreign phases were detectable in the X-ray diffractogram (XRD spectrum). The product was then sintered at 900° C. for six hours and then finely ground in a ball mill with porcelain spheres.

No signs of foreign phases were found in the product (FIG. 2). The total quantity of magnetic Fe, Cr and Ni and/or their compounds was 0.73 ppm. The quantity of Fe and/or its magnetic compound was 0.22 ppm in the present example. A comparison example produced according to JP A 1990 2-225310, on the other hand, contained 2.79 ppm, and 1.52 ppm of magnetic iron or iron compounds.

The structure of the product Li_{1.3}Al_{0.3}Ti_{1.7}(PO₄)₃ obtained according to the invention is shown in FIG. 1 and is similar to a so-called NASiCON (Na⁺ superionic conductor) structure (see Nuspl et al. J. Appl. Phys. Vol. 06, No. 10, p. 5484 et seq. (1999)).

The three-dimensional Li⁺ channels of the crystal structure and a simultaneously very low activation energy of 0.30 eV for the Li migration in these channels bring about a high intrinsic Li ion conductivity. The Al doping scarcely influences this intrinsic Li⁺ conductivity, but reduces the Li ion conductivity at the particle boundaries.

In addition to Li₃ₓLa_{2/3-x}TiO₃ compounds, Li_{1.3}Al_{0.3}Ti_{1.7}(PO₄)₃ is the solid-state electrolyte with the highest Li⁺ ion conductivity known in literature.

As can be seen from the X-ray powder diffractogram (XRD) of the product in FIG. 2, particularly phase-pure products result from the reaction process according to the invention.

FIG. 3 shows, in comparison to this, an X-ray powder diffractogram of a lithium aluminium titanium phosphate of the state of the art produced according to JP A 1990 2-225310 with foreign phases such as TiP₂O₇ and AlPO₄. The same foreign phases are also found in the material described by Kosova et al. (see above).

The particle-size distribution of the product from Example 1 is shown in FIG. 4 which has a purely monomodal particle-size distribution with values for d₉₀ of <6 μm, d₅₀ of <2.1 μm and d₁₀<1 μm.

1. Phase-pure lithium aluminium titanium phosphate of the formula Li₁₊ₓTi₂₋ₓAlₓ(PO₄)₃, wherein x is ≦0.4 and the level of magnetic metals and magnetic metal compounds of the elements Fe, Cr and Ni therein is ≦1 ppm.

2. Lithium aluminium titanium phosphate according to claim 1, the particle-size distribution d₉₀ of which is <6 μm.

3. Lithium aluminium titanium phosphate according to claim 1 or 2, the metal iron and magnetic iron compounds content of which is <0.5 ppm.

4. Lithium aluminium titanium phosphate according to claim 3, wherein the value for x is 0.2 or 0.3.

5. Method for producing Li₁₊ₓTi₂₋ₓAlₓ(PO₄)₃, wherein x is ≦0.4, according to one of the previous claims, comprising the steps of
a) providing a phosphoric acid
b) adding titanium dioxide
c) converting the mixture at a temperature of more than 100° C.
d) adding an oxygen-containing aluminium compound and a lithium compound
e) calcining the suspended reaction product obtained in step d).

6. Method according to claim 5, wherein a phosphoric acid selected from a liquid phosphoric acid, an aqueous phosphoric acid and/or a phosphoric acid in solution is used as phosphoric acid;
and/or wherein a dilute orthophosphoric acid is used as phosphoric acid.

7. Method according to claim 5 or 6, wherein lithium carbonate is used as lithium compound.

8. Method according to claims 5 to 7, wherein Al(OH)₃ is used as oxygen-containing aluminium compound.

9. Method according to one of claims 5 to 8, wherein the step c) is carried out at a temperature of from 140° C. to 200° C.

10. Method according to claim 9, wherein, after step d), the suspended reaction product is subjected to a spray-drying.

11. Method according to claim 10, wherein the calcining takes place at a temperature of from 850° C. to 950° C.

12. Method according to claim 11, wherein the calcining is carried out over a period of from 5 to 24 hours.

13. Phase-pure lithium aluminium titanium phosphate of the formula Li₁₊ₓTi₂₋ₓAlₓ(PO₄)₃, wherein x is ≦0.4, obtainable by the method according to one of the previous claims 6 to 12.

14. Use of phase-pure lithium aluminium titanium phosphate according to claim 1 to 4 or 13 as solid electrolyte in a secondary lithium ion battery.

15. Secondary lithium ion battery containing phase-pure lithium aluminium titanium phosphate according to one of claim 1 to 4 or 13.

16. Secondary lithium ion battery according to claim 15, further containing, as cathode material, a doped or non-doped lithium transition metal phosphate.

17. Secondary lithium ion battery according to claim 16, wherein the transition metal of the lithium transition metal phosphate is selected from Fe, Co, Ni, Mn, Cu, Cr.

18. Secondary lithium ion battery according to claim 17, wherein the transition metal is Fe.

19. Secondary lithium ion battery according to claim 18, wherein the cathode material contains a further doped or non-doped lithium transition metal oxo compound.

20. Secondary lithium ion battery according to one of claims 15 to 19, wherein the anode material contains doped or non-doped lithium titanate.
